(19) United States
(12) Patent Application Publication
(10) Pub. No.: US 2018/0213224 A1
(43) Pub. Date: Jul. 26, 2018

(54) INTRA PREDICTION METHOD AND DEVICE IN VIDEO CODING SYSTEM

(71) Applicant: LG Electronics Inc., Seoul (KR)

(72) Inventors: Eunyong SON, Seoul (KR); Yongjoon JEON, Seoul (KR); Jin HEO, Seoul (KR); Seungwook PARK, Seoul (KR); Moonmo KOO, Seoul (KR); Hyeongmoon JANG, Seoul (KR)

(21) Appl. No.: 15/746,139

(22) PCT Filed: Apr. 22, 2016
(86) PCT No.: PCT/KR2016/004199

§ 371 Date: Jan. 19, 2018

Related U.S. Application Data
(60) Provisional application No. 62/194,312, filed on Jul. 20, 2015.

(51) Int. Cl. H04N 19/11; H04N 19/124; H04N 19/159; H04N 19/176; H04N 19/96; H04N 19/52

(52) U.S. Cl. CPC H04N 19/11; H04N 19/124; H04N 19/52; H04N 19/176; H04N 19/96; H04N 19/159

(57) ABSTRACT

An intra prediction method performed by a decoding device, according to the present invention, comprises the steps of: deriving an intra prediction mode for a current block; deriving neighboring samples of the current block; and generating a prediction sample for the current block by using at least one of the neighboring samples according to the intra prediction mode, wherein the derived neighboring samples include left neighboring samples, upper left neighboring samples, upper neighboring samples, right neighboring samples, lower right neighboring samples, and lower neighboring samples of the current block. According to the present invention, intra prediction performance can be improved by using expanded neighboring reference samples, and coding efficiency for CUs can be improved.

### BACKGROUND OF THE INVENTION

### Field of the Invention

The present invention relates to a video coding technique, and more particularly, to an intra prediction method and device in a video coding system.

### Related Art

Demand for high-resolution, high-quality images such as HD (High Definition) images and UHD (Ultra High Definition) images has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY OF THE INVENTION

The present invention provides a method and a device for enhancing image coding efficiency.

Another technical purpose of the present invention is to provide a coding unit (CU) coding sequence to improve coding efficiency.

Another technical purpose of the present invention is to determine a coding sequence based on a prediction mode for the CU.

Another technical purpose of the present invention is to provide a method and device for improving intra prediction.

Another technical purpose of the present invention is to define positions of neighboring reference samples for a current block for efficient intra prediction.

Another technical purpose of the present invention is to provide a method and device for deriving neighboring reference samples for a current block.

Another technical purpose of the present invention is to provide intra prediction methods and devices using templates.

In accordance with one embodiment of the present invention, there is provided an intra prediction method performed by a decoding device. The method includes deriving an intra prediction mode for a current block; deriving neighboring samples to the current block; and generating predicted samples for the current block using at least one of the neighboring samples according to the intra prediction mode, wherein the derived neighboring samples include left neighboring samples, top-left neighboring sample, top neighboring samples, right neighboring samples, bottom-right neighboring sample, and bottom neighboring samples to the current block.

In accordance with another embodiment of the present invention, there is provided a decoding device for performing intra prediction. The decoding device includes a decoding module configured to obtain information on an intra prediction mode for a current block from a bitstream, and a prediction module configured to derive an intra prediction mode for the current block, to derive neighboring samples to the current block, and to generate predicted samples for the current block using at least one of the neighboring samples according to the intra prediction mode, wherein the derived neighboring samples include left neighboring samples, top-left neighboring sample, top neighboring samples, right neighboring samples, bottom-right neighboring sample, and bottom neighboring samples to the current block.

According to still another embodiment of the present invention, an image encoding method performed by an encoding device is provided. The image encoding method includes deriving an intra prediction mode for a current block, deriving neighboring samples to the current block, generating predicted samples for the current block using at least one of the neighboring samples according to the intra prediction mode, generating residual samples for the current block based on the predicted samples, and encoding and outputting information on the intra prediction mode and information on the residual samples, wherein the derived neighboring samples include left neighboring samples, top-left neighboring sample, top neighboring samples, right neighboring samples, bottom-right neighboring sample, and bottom neighboring samples to the current block.

According to still another embodiment of the present invention, an encoding device for performing image encoding is provided. The encoding device includes a prediction module configured to derive an intra prediction mode for a current block, to derive neighboring samples to the current block, and to generate predicted samples for the current block using at least one of the neighboring samples according to the intra prediction mode, a subtracting module configured to generate residual samples for the current block based on the predicted samples, and an encoding module configured to encode and output information on the intra prediction mode and information on the residual samples, wherein the derived neighboring samples include left neighboring samples, top-left neighboring sample, top neighboring samples, right neighboring samples, bottom-right neighboring sample, and bottom neighboring samples to the current block.

According to the present invention, coding sequences of CUs, which are basic processing units of an image, may be derive based on the prediction mode, thereby improving coding efficiency of CUs. Further, according to the present invention, intra prediction performance may be improved by using extended neighboring reference samples.

### BRIEF DESCRIPTION OF THE DRAWINGS

FIG. 1 is a block diagram schematically illustrating a video encoding device according to an embodiment of the invention.

FIG. 2 is a block diagram schematically illustrating a video decoding device according to an embodiment of the invention.

FIG. 3 shows an example of a sequence in which CUs in a CTU are processed.

FIG. 4 shows an example of reconstructed neighboring reference samples that may be used when intra prediction is performed for a current block.

FIG. 5 shows a CUs processing sequence adaptive to a prediction mode according to one embodiment of the present invention.

FIG. 6 shows extended neighboring reference samples for intra prediction according to one example of the present invention.

FIG. 7 illustrates exemplary intra prediction modes according to the present invention.

FIG. 8 exemplarily shows available neighboring reference samples when the intra prediction mode for the current block is intra DC mode.

FIG. 9 shows an embodiment of an intra prediction method utilizing linear interpolation according to the present invention.

FIG. 10 shows an exemplary TMP method according to the present invention.

FIG. 11 shows an example of neighboring samples used for constituting a target template.

FIG. 12 schematically illustrates one example of an image coding method according to the present invention.

FIG. 13 schematically shows one example of an intra prediction method according to the present invention.

### DESCRIPTION OF EXEMPLARY EMBODIMENTS

The present invention can be modified in various forms, and specific embodiments thereof will be described and shown in the drawings. However, the embodiments are not intended for limiting the invention. The terms used in the following description are used to merely describe specific embodiments, but are not intended to limit the invention. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the invention are independently drawn for the purpose of convenience for explanation of different specific functions in an image encoding/decoding device and does not mean that the elements are embodied by independent hardware or independent software. For example, two or more elements of the elements may be combined to form a single element, or one element may be divided into plural elements. The embodiments in which the elements are combined and/or divided belong to the invention without departing from the concept of the invention.

Hereinafter, exemplary embodiments of the invention will be described in detail with reference to the accompanying drawings.

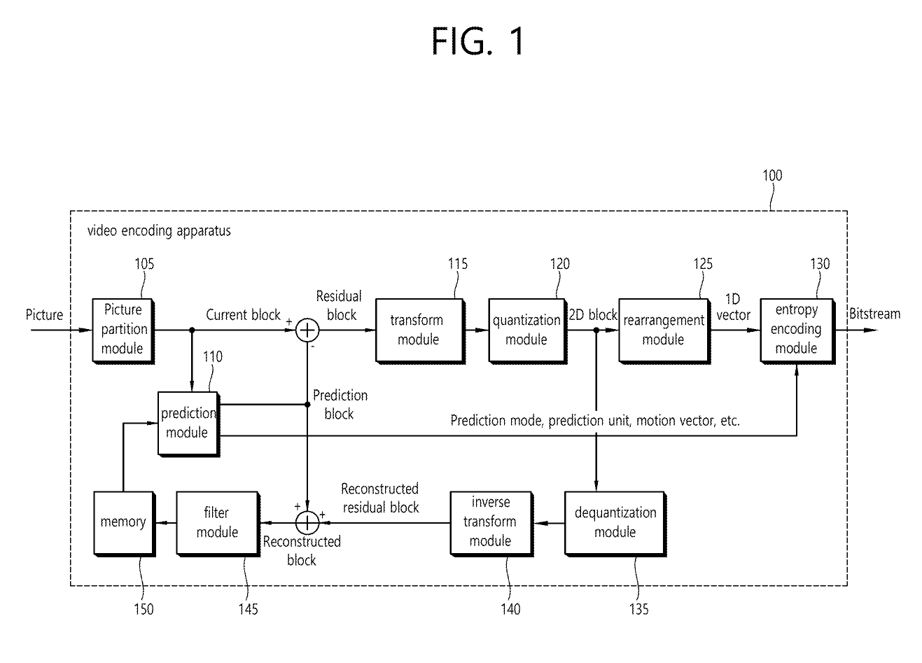

FIG. 1 is a block diagram schematically illustrating a video encoding device according to an embodiment of the invention.

Referring to FIG. 1, a video encoding device 100 includes a picture partitioning module 105, a prediction module 110, a transform module 115, a quantization module 120, a rearrangement module 125, an entropy encoding module 130, a dequantization module 135, an inverse transform module 140, a filtering module 145, and memory 150.

The picture partitioning module 105 may be configured to split the input picture into at least one processing unit block. In this connection, a block as a processing unit may be a prediction unit PU, a transform unit TU, or a coding unit CU. The picture may be composed of a plurality of coding tree unit CTUs. Each CTU may be split into CUs as a quad tree structure. The CU may be split into CUs having a deeper depth as a quad-tree structures. The PU and TU may be obtained from the CU. For example, the PU may be partitioned from a CU into a symmetric or asymmetric square structure. Further, the TU may be split into a quad tree structure from the CU. The CTU may correspond to a coding tree block CTB, the CU may correspond to a coding block CB, the PU may correspond to a prediction block PB and the TU may correspond to a transform block TB.

The prediction module 110 includes an inter prediction unit that performs an inter prediction process and an intra prediction unit that performs an intra prediction process, as will be described later. The prediction module 110 performs a prediction process on the processing units of a picture divided by the picture dividing module 105 to create a prediction block including a predicted samples or a predicted samples array. In the prediction module 110, the processing unit of a picture may be a CU, a TU, or a PU. The prediction module 110 may determine whether the prediction performed on the corresponding processing unit is an inter prediction or an intra prediction, and may determine specific details for example, a prediction mode of the prediction methods. The processing unit subjected to the prediction process may be different from the processing unit of which the prediction method and the specific details are determined. For example, the prediction method and the prediction mode may be determined in the units of PU and the prediction process may be performed in the units of TU.

In the inter prediction, a prediction process may be performed on the basis of information on at least one of a previous picture and/or a subsequent picture of a current picture to create a prediction block. In the intra prediction, a prediction process may be performed on the basis of pixel information of a current picture to create a prediction block.

As an inter prediction method, a skip mode, a merge mode, and Advanced Motion Vector Prediction (AMVP) may be used. In inter prediction, a reference picture may be selected for the PU and a reference block corresponding to the PU may be selected. The reference block may be selected on an integer pixel (or sample) or fractional pixel (or sample) basis. Then, a prediction block is generated in which the residual signal with respect to the PU is minimized and the motion vector magnitude is also minimized. Pixels, pels, and samples may be used interchangeably herein.

A prediction block may be generated as an integer pixel unit, or as a fractional pixel unit such as a ½ pixel unit or a ¼ pixel unit. In this connection, a motion vector may also be expressed as a fractional pixel unit.

Information such as the index of the reference picture selected via the inter prediction, the motion vector difference MDV, the motion vector predictor MVP, residual signal, etc., may be entropy encoded and then transmitted to the decoding device. When the skip mode is applied, the prediction block may be used as a reconstruction block, so that the residual may not be generated, transformed, quantized, or transmitted.

When the intra prediction is performed, the prediction mode may be determined in the unit of PU and the prediction process may be performed in the unit of PU. Alternatively, the prediction mode may be determined in the unit of PU and the inter prediction may be performed in the unit of TU.

The prediction modes in the intra prediction may include 33 directional prediction modes and at least two non-directional modes, as an example. The non-directional modes may include a DC prediction mode and a planar mode.

In the intra prediction, a prediction block may be constructed after a filter is applied to a reference sample. At this time, it may be determined whether a filter should be applied to a reference sample depending on the intra prediction mode and/or the size of a current block.

Residual values (a residual block or a residual signal) between the constructed prediction block and the original block are input to the transform module 115. The prediction mode information, the motion vector information, and the like used for the prediction are encoded along with the residual values by the entropy encoding module 130 and are transmitted to the decoding device.

The transform module 115 performs a transform process on the residual block in the unit of TUs and generates transform coefficients.

A transform block is a rectangular block of samples and is a block to which the same transform is applied. The transform block may be a TU and may have a quad-tree structure.

The transform module 115 may perform a transform process depending on the prediction mode applied to a residual block and the size of the block.

For example, when intra prediction is applied to a residual block and the residual block has an 4×4 array, the residual block is transformed using discrete sine transform DST. Otherwise, the residual block may be transformed using discrete cosine transform DCT.

The transform module 115 may construct a transform block of transform coefficients through the transform.

The quantization module 120 may quantize the residual values, that is, transform coefficients, transformed by the transform module 115 and may create quantization coefficients.

The values calculated by the quantization module 120 may be supplied to the dequantization module 135 and the rearrangement module 125.

The rearrangement module 125 may rearrange the transform coefficients supplied from the quantization module 120. By rearranging the quantization coefficients, it is possible to enhance the encoding efficiency in the entropy encoding module 130.

The rearrangement module 125 may rearrange the quantized transform coefficients in the form of a two-dimensional block to the form of a one-dimensional vector through the use of a coefficient scanning method.

The entropy encoding module 130 may be configured to entropy code the symbol according to a probability distribution based on the quantized transform values rearranged by the rearrangement module 125 or the encoding parameter value calculated during the encoding process, etc. and then to output a bit stream. The entropy encoding method is a method of receiving a symbol having various values and expressing the symbol as a binary string that can be decoded while removing statistical redundancy thereof.

In this connection, the symbol means the to-be encoded/decoded syntax element, coding parameter, residual signal value and so on. The encoding parameter is required for encoding and decoding. The encoding parameter may contain information that can be inferred during encoding or decoding, as well as information encoded in an encoding device and passed to a decoding device like the syntax element. The encoding parameter is the information needed to encode or decode the image. The encoding parameter may include statistics or values such as for example, the intra/inter prediction mode, movement/motion vector, reference picture index, coding block pattern, residual signal presence or absence, transform coefficient, quantized transform coefficient, quantization parameter, block size, block partitioning information, etc. Further, the residual signal may mean a difference between an original signal and a prediction signal. Further, the difference between the original signal and the prediction signal may be transformed to define the residual signal, or the difference between the original signal and the prediction signal may be transformed and quantized to define the residual signal. The residual signal can be called the residual block in the block unit, and can be called the residual samples in the sample unit.

When the entropy encoding is applied, the symbols may be expressed so that a small number of bits are allocated to a symbol having a high probability of occurrence, and a large number of bits are allocated to a symbol having a low probability of occurrence. This may reduce the size of the bit string for the to-be-encoded symbols. Therefore, the compression performance of image encoding may be increased via the entropy encoding.

Encoding schemes such as exponential Golomb, Context-Adaptive Variable Length Coding (CAVLC), and Context-Adaptive Binary Arithmetic Coding (CABAC) may be used for the entropy encoding. For example, the entropy encoding module 130 may store therein a table for performing entropy encoding, such as a variable length coding/code (VLC) table. The entropy encoding module 130 may perform entropy encoding using the stored VLC table.

Further, the entropy encoding module 130 derives a binarization method of a corresponding symbol and a probability model of a corresponding symbol/bin, and then performs entropy encoding using the derived binarization method or probability model.

The entropy encoding module 130 may give a predetermined change to a parameter set or syntaxes to be transmitted, if necessary.

The dequantization module 135 dequantizes the values transform coefficients quantized by the quantization module 120. The inverse transform module 140 inversely transforms the values dequantized by the dequantization module 135.

The residual value or residual samples or residual samples array generated by the dequantization module 135 and the inverse-transform module 140, and the prediction block predicted by the prediction module 110 may be combined to form a reconstructed block including a reconstructed sample or a reconstructed sample array.

In FIG. 1, a residual block and a prediction block are added to create a reconstructed block by an adder. At this time, the adder may be considered as a particular unit reconstructed block creating unit that generates a reconstructed block.

The filtering module 145 applies a deblocking filter, an ALF Adaptive Loop Filter, an SAO Sample Adaptive Offset to the reconstructed picture.

The deblocking filter removes a block distortion generated at the boundary between blocks in the reconstructed picture. The ALF performs a filtering process on the basis of the result values of the comparison of the original picture with the reconstructed picture of which the blocks are filtered by the deblocking filter. The ALF may be applied only when high efficiency is necessary. The SAO reconstructs offset differences between the residual blocks having the deblocking filter applied thereto and the original picture and is applied in the form of a band offset, an edge offset, or the like.

On the other hand, the filtering module 145 may not perform a filtering operation on the reconstructed block used in the inter prediction.

The memory 150 may store the reconstructed block or picture calculated by the filtering module 145. The reconstructed block or picture stored in the memory 150 may be supplied to the prediction module 110 that performs the inter prediction.

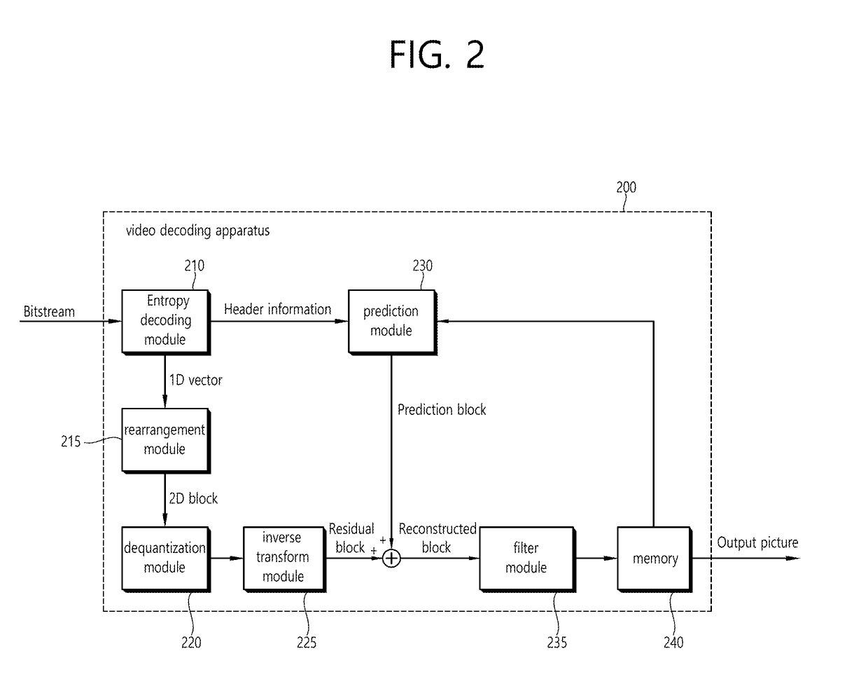

FIG. 2 is a block diagram schematically illustrating a video decoding device according to an embodiment of the invention. Referring to FIG. 2, a video decoding device 200 may include an entropy decoding module 210, a rearrangement module 215, a dequantization module 220, an inverse transform module 225, a prediction module 230, a filtering module 235, and memory 240.

When a video bitstream is input from the video encoding device, the input bitstream may be decoded on the basis of the order in which video information is processed by the video encoding device.

The entropy decoding module 210 may entropy-decode the input bitstream according to a probability distribution to generate symbols in a quantized coefficient form. The entropy decoding method is a method of receiving a sequence of binary numbers and generating each of the symbols using the sequence. The entropy decoding method is similar to the entropy encoding method described above.

For example, when a Variable Length Coding VLC (hereinafter referred to as ‘VLC’) such as CAVLC is used to perform entropy encoding in a video encoding device, the entropy decoding module 210 may perform decoding using the same VLC table as the encoding device used in the encoding device. Further, when CABAC is used to perform entropy encoding in a video encoding device, the entropy decoding module 210 may perform the entropy decoding using CABAC.

More specifically, the CABAC entropy decoding method may include receiving a bin corresponding to each syntax element in a bitstream, determining a context model using to-be-decoded syntax element information, decoding information of a neighboring block and a to-be-decoded block, or information of a symbol/bin decoded in a previous step, and predicting a probability of occurrence of a bin according to the determined context model and thus performing arithmetic decoding of the bin to generate a symbol corresponding to a value of each syntax element. In this connection, after determining the context model, the CABAC entropy decoding method may further include a step of updating the context model using the information of the decoded symbol/bin to determine a context model of the next symbol/bin.

Information for constructing a predicted block out of the information decoded by the entropy decoding module 210 may be supplied to the prediction module 230, and the residual values, that is, the quantized transform coefficients, entropy-decoded by the entropy decoding module 210 may be input to the rearrangement module 215.

The rearrangement module 215 may rearrange the bitstream information, that is, the quantized transform coefficients, entropy-decoded by the entropy decoding module 210 on the basis of the rearrangement method in the video encoding device.

The rearrangement module 215 may reconstruct and rearrange the coefficients expressed in the form of a one-dimensional vector into coefficients in the form of a two-dimensional block. The rearrangement module 215 may scan the coefficients on the basis of the prediction mode applied to the current block transform block and the size of the transform block and may create an array of coefficients quantized transform coefficients in the form of a two-dimensional block.

The dequantization module 220 may perform dequantization on the basis of the quantization parameters supplied from the video encoding device and the coefficient values of the rearranged block.

The inverse transform module 225 may perform the inverse DCT and/or inverse DST of the DCT and/or DST, which has been performed by the transform module of the video encoding device, on the quantization result from the video encoding device.

The inverse transform may be performed on the basis of a transfer unit or a partition unit of a picture determined by the video encoding device. The transform module of the video encoding device may selectively perform the DCT and/or DST depending on plural information pieces such as the prediction method, the size of a current block, and the prediction direction, and the inverse transform module 225 of the video decoding device may perform the inverse transform on the basis of the transform information on the transform performed by the transform module of the video encoding device.

The prediction module 230 generates a prediction block including a predicted samples or a predicted samples array based on the prediction block generation-related information provided by the entropy decoding module 210 and the previously decoded block and/or picture information provided from the memory 240.

If the prediction mode for the current PU is the intra prediction mode, the prediction module 230 may perform the intra prediction to generate a prediction block based on pixel information in the current picture.

If the prediction mode for the current PU is the inter prediction mode, the prediction module 230 may be configured to perform inter prediction on a current PU based on information included in at least one picture of a previous picture or a subsequent picture to the current picture. In this connection, information about the motion information necessary for inter prediction of the current PU provided in the video encoding device, such as motion vector and reference picture index may be deduced via checking the skip flag and merge flag received from the encoding device.

The prediction module 230 may generate a prediction block such that the residual signal relative to the current block is minimized and the motion vector size is minimized when inter prediction is performed on the current picture.

On the other hand, the motion information derivation method may be changed according to the prediction mode of the current block. The prediction mode applied to inter prediction may include an Advanced Motion Vector Prediction (AMVP) mode, a merge mode, and the like.

For example, when a merge mode is applied, the encoding device and the decoding device may generate a merge candidate list using the motion vector of the reconstructed spatial neighboring block and/or the motion vector corresponding to the Col block which is a temporally neighboring block. In the merge mode, the motion vector of the candidate block selected in the merge candidate list is used as the motion vector of the current block. The encoding device may transmit a merge index indicating a candidate block having an optimal motion vector selected from the candidate blocks included in the merge candidate list to the decoding device. In this case, the decoding device may derive the motion vector of the current block using the merge index.

In another example, when the AMVP (Advanced Motion Vector Prediction) mode is applied, the encoding device and decoding device generate a motion vector predictor candidate list using a motion vector of a reconstructed spatial neighboring block and/or a motion vector corresponding to a Col block as a temporal neighboring block. That is, the motion vector of the reconstructed spatial neighboring block and/or the motion vector corresponding to the Col block as a temporal neighboring block may be used as a motion vector candidate. The encoding device may transmit to the decoding device a prediction motion vector index indicating the optimal motion vector selected from among the motion vector candidates included in the motion vector predictor candidate list. In this connection, the decoding device may select the prediction motion vector for the current block from the motion vector candidates included in the motion vector candidate list using the motion vector index.

The encoding device may obtain the motion vector difference MVD between the motion vector for the current block and the motion vector predictor (MVP), encode the MVD, and transmit the encoded MVD to the decoding device. That is, the MVD may be a value obtained by subtracting the motion vector predictor (MVP) from the motion vector (MV) for the current block. In this connection, the decoding device may decode the received motion vector difference, and derive the motion vector for the current block via addition between the decoded motion vector difference and the motion vector predictor.

Further, the encoding device may transmit a reference picture index indicating a reference picture to the decoding device.

The decoding device may predict the motion vector of the current block using the motion information of the neighboring block and derive the motion vector of the current block using the residual received from the encoding device. The decoding device may generate predicted samples (or predicted samples array) for the current block based on the derived motion vector and the reference picture index information received from the encoding device.

The decoding device may generate reconstructed samples (or reconstructed samples array) by adding predicted samples (or predicted samples array) and residual samples as obtained from transform coefficients sent from the encoding device to each other. Based on these reconstructed samples, reconstructed blocks and reconstructed pictures may be generated.

In the above-described AMVP and merge modes, motion information of the reconstructed neighboring block and/or motion information of the Col block may be used to derive motion information of the current block.

In the skip mode, which is one of the other modes used for inter-picture prediction, neighboring block information may be used for the current block as it is. Therefore, in the case of skip mode, the encoding device does not transmit syntax information such as the residual to the decoding device in addition to information indicating which block's motion information to use as the motion information for the current block.

The reconstructed block may be generated using the prediction block generated by the prediction module 230 and the residual block provided by the inverse-transform module 225. FIG. 2 illustrates that using the adder, the prediction block and the residual block are combined to generate the reconstructed block. In this connection, the adder may be viewed as a separate module (a reconstructed block generation module) that is configured to generate the reconstructed block. In this connection, the reconstructed block includes a reconstructed samples or a reconstructed samples array as described above; the prediction block includes a predicted samples or a predicted samples array; the residual block may include a residual samples or a residual samples array. Therefore, the reconstructed samples or the reconstructed samples array can be considered to be generated by combining the corresponding predicted samples or predicted samples array with the corresponding residual samples or residual samples array.

When the skip mode is used for a block, the residual signal may not be transmitted and the predicted block may be used as a reconstructed block.

The reconstructed block and/or picture may be supplied to the filtering module 235. The filtering module 235 may perform a deblocking filtering operation, an SAO operation, and/or an ALF operation on the reconstructed block and/or picture.

The memory 240 may store the reconstructed picture or block for use as a reference picture or a reference block and may supply the reconstructed picture to an output unit.

The elements that is directly related to decoding images among the entropy decoding module 210, the rearrangement module 215, the dequantization module 220, the inverse transform module 225, the prediction module 230, the filtering module 235 and the memory 240 which are included in the decoding device 200, for example, the entropy decoding module 210, the rearrangement module 215, the dequantization module 220, the inverse transform module 225, the prediction module 230, the filtering module 235, and so on may be expressed as a decoder or a decoding module that is distinguished from other elements.

In addition, the decoding device 200 may further include a parsing module not shown in the drawing that parses information related to the encoded images included in a bitstream. The parsing module may include the entropy decoding module 210, and may be included in the entropy decoding module 210. Such a parsing module may also be implemented as an element of the decoding module.

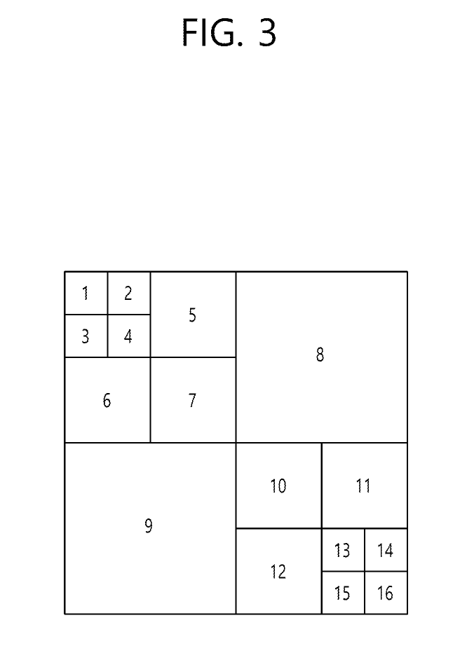

As described above, the picture may be composed of a plurality of coding tree units (CTUs), and each CTU may be split into CUs in a quadtree structure. The CU may be divided into CUs of lower deeper depth in a quadtree structure. In some cases, the CTU may be a single CU. In this case, the image characteristics may be considered. That is, the region having a simple and smooth image may be coded using relatively large CU units. In case of the region having a complex image, CU units are further divided into deeper CU units, and, thus, the region may be coded using relatively smaller CU units. In this case, the picture is coded in a raster scan order using the CTU units. The final CUs in one CTU may be coded in the raster scan order. This may be represented, for example, as shown in FIG. 3.

FIG. 3 shows an example of a sequence in which CUs in a CTU are processed.

Referring to FIG. 3, each block represents a CU, and numbers in blocks represent a processing sequence. That is, the encoding device may encode the CUs based on the sequences of the CUs, and the decoding device may decode the CUs based on the sequences of the CUs and thus generate reconstructed samples. Such a processing sequence may be referred to as a depth first order or z-scan order. Accordingly, as for one CTU, starting from a CU positioned at the top-left position, four CUs divided in the quad tree structure are coded in the z-scan order of the upper left, upper right, lower left and lower right in this order. If a particular CU is again divided in a quadtree structure, the divided CUs are again coded in a z-scan order. Then, the process proceeds with a next CU.

Since the CUs positioned above and to the left of the current CU subject to the current processing are coded first, based on the z scan order, the samples and coding parameters (for example, intra prediction modes) of the first coded CUs may be used in intra prediction for the current CU.

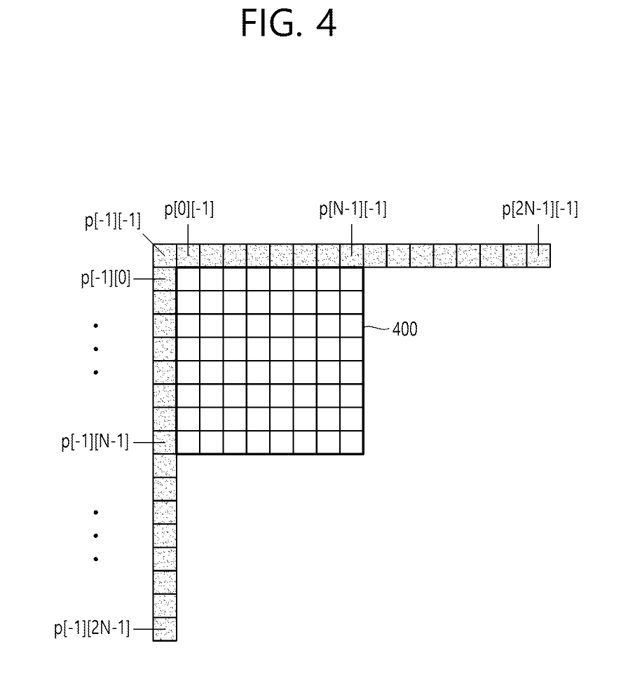

FIG. 4 shows an example of reconstructed neighboring reference samples that may be used when intra prediction is performed for a current block. Here, the current block may be TU (or TB). The TU may be derived from a CU. One TU may be derived from one CU, multiple TUs may be derived from one CU in a quadtree structure.

Referring to FIG. 4, left neighboring samples (p[−1][2N−1] . . . p[−1][0]), top-left neighboring sample (p[−1][−1]), and top neighboring samples (p[0][−1] . . . p[2N−1][−1]) may be derived as neighboring reference samples for intra prediction of current block 400. In this connection, p[m][n] represents a sample (or pixel) having the sample position (m, n). This position may refer to a relative sample position when the top-left sample position of the current block is considered (0, 0). In this connection, N represents the size of the current block 400. The N may correspond to the width or height of the current block 400. If the current block 400 is a transform block, the N may be denoted nTbS.

On the other hand, if there are non-available sample for intra prediction among the neighboring samples (p[−1][2N−1] . . . p[−1][−1] p[2N−1][−1]), the corresponding non-available samples may be filled with available samples via a substitution or padding procedure. In this case, for example, the non-available samples may be substituted or padded with another neighboring samples neighboring to the corresponding sample.

In this connection, in one example, the corresponding sample may be a non-available sample if the position of the corresponding sample is located at the outer edge of the picture. For example, if the current block 400 is positioned at the edge of the picture, some of the neighboring samples may not be available for intra prediction.

In another example, if another CU containing the corresponding sample is not yet coded, the corresponding sample may be a non-available sample. For example, assuming that a 4th block in FIG. 3 is the current CU, and one current TU of the same size and position is derived from the current CU, p[N][−1] to p[2N−1][−1] samples may not be available among the neighboring samples to the current TU. This is because the p[N][−1] to p[2N−1][−1] samples belong to the 5th CU and the current 4th CU is being coded, and, thus, the p[N][−1] to p[2N−1][−1] samples have not yet been reconstructed and therefore may not be available.

Further, the substitution or padding procedure can be performed, for example, in the following sequence:

1) If neighboring sample p[−1][2N−1] is non-available, the neighboring samples p[−1][2N−1] (or neighboring sample p[−1][2N−2]) to p[−1][−1] are sequentially searched, and, then, neighboring sample p[0][−1] to p[2N−1][−1] are sequentially searched. The value of an available neighboring sample found for the first time may be assigned to the neighboring sample p[−1][2N−1].

2) Neighboring samples are sequentially searched from x=−1, y=2N−2 to x=−1, y=−1. If neighboring sample p[x][y] is non-available, the value of neighboring sample p[x][y+1] is substituted into the value of the non-available p[x][y].

3) Neighboring samples are sequentially searched from x=0, y=−1 to x=2N−1, y=−1. If neighboring sample[x][y] is non-available, the value of neighboring sample p[x−1][y] is substituted into the value of the non-available p[x][y].

On the other hand, according to the present invention, when coding the CUs according to the z scan order, the processing sequence may be changed according to the prediction mode of the CUs. For example, divided CUs in the CTU may be divided into two groups according to the prediction mode. In this case, among CUs divided in the CTU, CUs coded in inter prediction mode (i.e., having an inter prediction mode) may be classified into group A, while among the CUs divided in the CTU, CUs coded in the intra prediction mode may be classified as group B.

According to one embodiment of the present invention, in this case, the CUs of the group A may be first encoded/decoded and the CUs of the group B may be subsequently encoded/decoded.

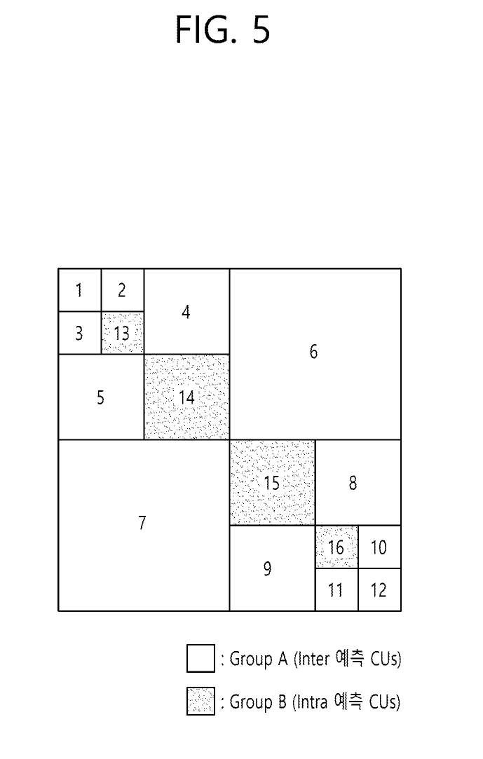

FIG. 5 shows a CUs processing sequence adaptive to a prediction mode according to one embodiment of the present invention.

Referring to FIG. 5, non-shaded blocks represent inter-predicted CUs (group A), and shaded blocks represent intra-predicted CUs (group B). In this connection, an inter-predicted CU indicates that the prediction mode for the corresponding CU is the inter prediction mode. An intra-predicted CU indicates that the prediction mode for the corresponding CU is the intra prediction mode.

In this case, as shown in FIG. 5, the inter-predicted CUs among the CUs in the CTU are encoded/decoded first, and then intra-predicted CUs are encoded/decoded. In this case, in encoding/decoding the intra-predicted CUs, the inter-predicted CUs that are coded first may be referred to. Particularly, the category of available neighboring reference samples in intra prediction of the intra-predicted CUs may be extended.

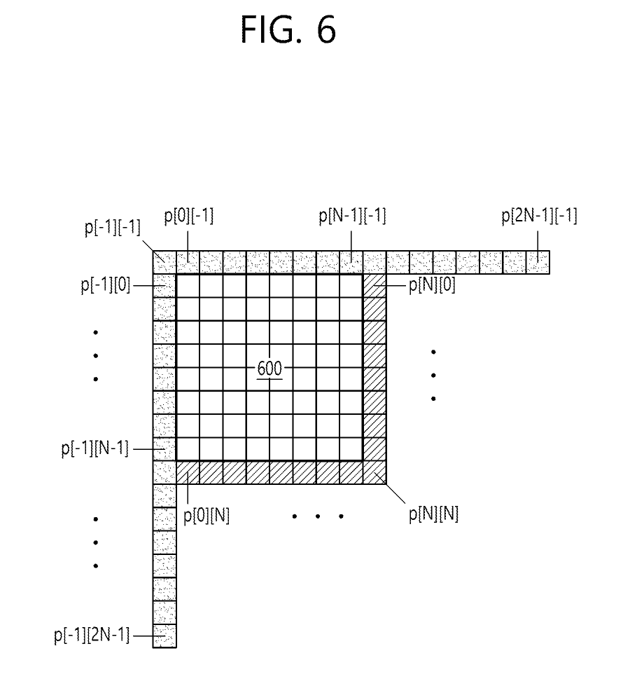

FIG. 6 shows extended neighboring reference samples for intra prediction according to one example of the present invention.

Referring to FIG. 6, as neighboring (reference) samples for intra prediction of the current block 600, there may be derived left neighboring samples(p[−1][2N−1] . . . p[−1][0]), top-left neighboring sample(p[−1][−1]), top neighboring samples(p[0][−1] . . . p[2N−1][−1]), bottom neighboring samples(p[0][N] . . . p[N−1][N]), bottom-right neighboring sample(p[N][N]) and right neighboring samples(p[N][N−1] . . . p[N][0]).

In other words, when changing the processing sequence of CUs according to the present invention, the bottom neighboring samples(p[0][N] . . . p[N−1][N]), bottom-right neighboring sample(p[N][N]) and right neighboring samples(p[N][N−1] . . . p[N][0]) may be further used for intra prediction.

On the other hand, even in this case, due to the divided structure of the CTU, some or all of the bottom neighboring samples(p[0][N] . . . p[N−1][N]), bottom-right neighboring sample(p[N][N]) and right neighboring samples(p[N][N−1] . . . p[N][0]) may not be available. In this case, the non-available samples may be filled with available samples via a substitution or padding procedure.

In one example, when all of the bottom neighboring samples(p[0][N] . . . p[N−1][N]), bottom-right neighboring sample(p[N][N]) and right neighboring samples(p[N][N−1] . . . p[N][0]) are not be available, a value derived via interpolation(or averaging) between the sample p[−1][N] and sample p[N][−1] or between the sample p[−1][2N−1] and sample p[2N−1][−1] may be assigned to the sample p[N][N]. Then, a value derived via interpolation(or averaging) between the sample p[N][N] and sample p[−1][N] may be assigned to each of the bottom neighboring samples(p[0][N] . . . p[N−1][N]) depending on the positions. Further, a value derived via interpolation(or averaging) between the sample p[N][N] and sample p[N][−1] may be assigned to each of the right neighboring samples(p[N][N−1] . . . p[N][0]) depending on the positions.

In another example, when at least one of the bottom neighboring samples(p[0][N] . . . p[N−1][N]), bottom-right neighboring sample(p[N][N]) and right neighboring samples(p[N][N−1] . . . p[N][0]) is not available, the substitution or padding procedure can be performed, for example, in the following sequence:

1) If neighboring sample p[0][N] is non-available, the neighboring samples p[0][N] (or neighboring sample p[1][N]) to p[N][N] are sequentially searched, and, then, neighboring sample p[N][N−1] to p[N][0] are sequentially searched. The value of an available neighboring sample found for the first time may be assigned to the neighboring sample p[0][N].

2) Neighboring samples are sequentially searched from x=1, y=N to x=N, y=N. If neighboring sample p[x][y] is non-available, the value of neighboring sample p[x−1][y] is substituted into the value of the non-available p[x][y].

3) Neighboring samples are sequentially searched from x=N, y=N−1 to x=N, y=0. If neighboring sample[x][y] is non-available, the value of neighboring sample p[x][y+1] is substituted into the value of the non-available p[x][y]. Further, neighboring samples are sequentially searched from x=N, y=0 to x=N, y=N−1. If neighboring sample[x][y] is non-available, the value of neighboring sample p[x][y−1] is substituted into the value of the non-available p[x][y].

When extended neighboring samples are used for intra prediction according to the present invention, the following intra prediction modes may be utilized.

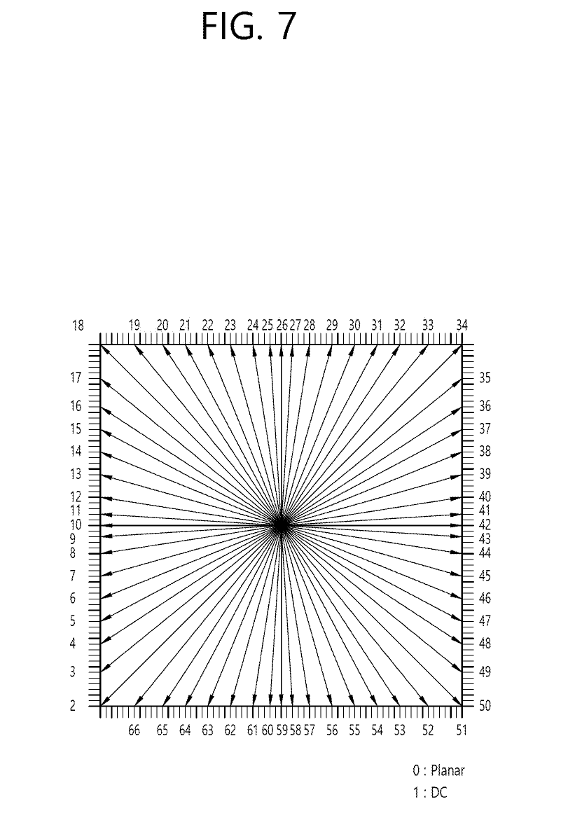

FIG. 7 illustrates exemplary intra prediction modes according to the present invention.

Referring to FIG. 7, the intra prediction modes according to the present invention may include two non-directional prediction modes and 65 directional prediction modes. In this connection, mode 0 represents intra planar mode, and mode 1 represents intra DC mode. The remaining prediction modes 2 to 66 are intra directional modes, each having a prediction direction as shown. The intra directional mode may be referred to as the intra angular mode.

In one example, if the intra directional mode is applied, the value of the neighboring sample that is positioned in the prediction direction based on the target sample in the current block may be derived as the predicted sample value of the target sample. If the neighboring sample of the integer sample unit is not positioned in the prediction direction based on the target sample, a sample of a fractional sample unit positioned in the corresponding prediction direction may be derived based on the interpolation between neighboring samples of the integer sample unit positioned adjacent to the corresponding prediction direction. A value of the derived sample of the fractional sample unit may be derived as the predicted sample value of the target sample.

As another example, if the intra prediction mode for the current block is intra DC mode, a single value may be used as the prediction value of the samples in the current block. For example, said single value may be derived based on left, right, top, and bottom neighboring samples to the current block.

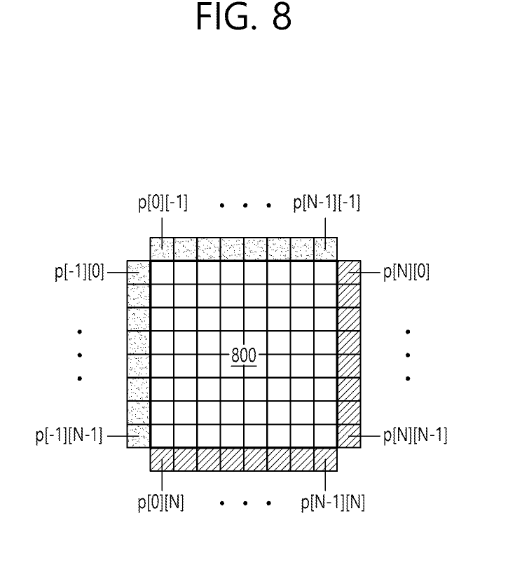

FIG. 8 exemplarily shows available neighboring reference samples when the intra prediction mode for the current block is intra DC mode.

Referring to FIG. 8, when intra DC mode is applied, left neighboring samples(p[−1][0] . . . p[−1][N−1]), right neighboring samples(p[N][0] . . . p[N][N−1]), top neighboring samples(p[0][−1] . . . p[N−1][−1]), and bottom neighboring samples(p[0][N] . . . p[N−1][N]) to the current block 800 may be derived as reference samples. In this case, a single value may be derived based on the left neighboring samples(p[−1][0] . . . p[−1][N−1]), right neighboring samples(p[N][0] . . . p[N][N−1]), top neighboring samples(p[0][−1] . . . p[N−1][−1]), and bottom neighboring samples(p[0][N] . . . p[N−1][N]) to the current block 800. The single value may be used as a prediction value for samples in the current block 800. That is, the present approach may derive predicted samples for the current block 800 based on said single value.

Specifically, for example, the single value may be derived using the following equation:

$$p [ x ] [ y ] = \frac{ \begin{matrix}( {\sum }_{i = 0}^{N - 1} p [ - 1 ] [ i ] + {\sum }_{j = 0}^{N - 1} p [ j ] [ - 1 ] + \\ {\sum }_{k = 0}^{N - 1} p [ N ] [ k ] + {\sum }_{l = 0}^{N - 1} p [ l ] [ N ] )\end{matrix}}{4 N} \qquad [ Equation 1 ]$$

In this connection, x=0 . . . N−1, and y=0 . . . N−1. Further, in this connection, N may represent the size of the current block as described above. That is, the current block may be a block having N×N sample size (hereinafter, N×N block). In this connection, N may be a positive integer. When the current block is a transform block (TB), the N may be denoted nTbS.

As another example, if the intra prediction mode for the current block is intra planar mode, the prediction value for the target sample in the current block may be derived based on four samples among the neighboring samples. In this case, based on the position of the target sample, two neighboring samples that are positioned in the same column as the target sample and two neighboring samples that are positioned in the same row as the target sample may be used as the four samples. For example, if the target sample is p[x][y], the prediction value of the p[x][y] may be derived based on the neighboring samples p[−1][y], p[N][y], p[x][−1], and p[x][N].

Specifically, for example, the prediction value may be derived using the following equation:

p[x][y]=((N−1−x)*p[−1][y]+(x+1)*p[N][y]+(N−1−y)*p[x][−1]+(y+1)*p[x][N]+N)»(log 2(N)+1) [Equation 2]

In this connection, x=0 . . . N−1, and y=0 . . . N−1. Further, in this connection, N may represent the size of the current block as described above. That is, the current block may be a block having N×N sample size (hereinafter, N×N block). In this connection, N may be a positive integer. When the current block is a transform block (TB), the N may be denoted nTbS.

When the intra directional mode is used, the prediction direction as well as the opposite direction to the prediction direction may be considered to derive the prediction value of the target sample in the current block.

For example, when a single prediction direction is derived according to intra directional mode, the prediction value for the target sample may be derived using the first neighboring (reference) sample that is positioned in the prediction direction from the target sample and the second neighboring (reference) sample positioned in the opposite direction to the prediction direction. That is, the predicted sample value for the target sample may be derived based on the first neighboring sample and the second neighboring sample.

In this case, the prediction value for the target sample may be derived via linear interpolation between the first neighboring sample and the second neighboring sample. This may be applied, for example, when the value of bidirectional prediction flag (or intra interpolation flag) is 1. The bidirectional prediction flag (or intra-interpolation flag) may be transmitted from the encoding device to the decoding device in a bitstream.

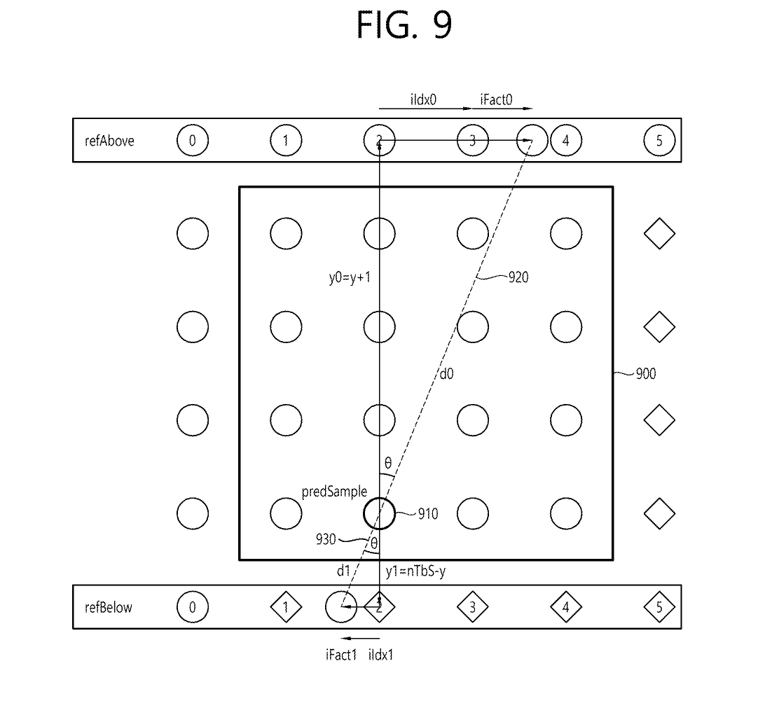

FIG. 9 illustrates an embodiment of the intra prediction method using the linear interpolation technique according to the present invention.

Referring to FIG. 9, the prediction mode for the current block 900 is the intra directional mode, and the intra prediction angle according to the intra directional mode is e. For example, the intra prediction angle may be derived based on the following table:

TABLE 1

| predModeIntra | 1 | 2 | 3 | 4 | 5 | 6 | 7 | 8 | 9 | 10 | 11 | 12 | 13 | 14 | 15 | 16 | 17 |
|---|---|---|---|---|---|---|---|---|---|---|---|---|---|---|---|---|---|
| intraPredAngle | — | 32 | 26 | 21 | 17 | 13 | 9 | 5 | 2 | 0 | −2 | −5 | −9 | −13 | −17 | −21 | −26 |
| predModeIntra | 18 | 19 | 20 | 21 | 22 | 23 | 24 | 25 | 26 | 27 | 28 | 29 | 30 | 31 | 32 | 33 | 34 |
| intraPredAngle | −32 | −26 | −21 | −17 | −13 | −9 | −5 | −2 | 0 | 2 | 5 | 9 | 13 | 17 | 21 | 26 | 32 |

In this connection, predModeIntra corresponds to the index of intra prediction mode. The index corresponds to the value described above in FIG. 7. intraPredAngle corresponds to the intra prediction angle.

In one example, when the prediction direction for the target predicted sample 910 based on the intra directional mode is a linear segment 920 direction, the value of the target predicted sample 910 may be derived as follows:

TABLE 2
iIdx = (intraPredAngle*y0) >> 5
iFact = (intraPredAngle*y0) & 31
predSample = ( ( 32 − iFact ) * ref(Above)[ x + iIdx + 1 ] + iFact *
ref(Above)[ x + iIdx + 2 ] + 16 ) >> 5

Referring to Table 2, predSample corresponds to the target predicted sample 910 and ref (Above)[m] refers to a top reference sample with an x coordinate being m. In this connection, since the integer reference sample does not exist in the prediction direction based on the target predicted samples 910, a fractional reference sample is derived and the value of the target predicted sample is derived based on the fractional reference sample. Although it is shown in Table 1 that the top reference sample is used, this is merely an example. Thus, the left reference sample, etc. may be used according to the prediction direction of intra directional mode.

In another example, when the prediction direction for the target predicted sample 910 according to the intra directional mode is a linear segment 920 direction, the value of the target predicted sample 910 may be derived considering the prediction direction and the opposite direction to the prediction direction. In this case, the value of the target predicted sample 910 may be derived as follows:

TABLE 3
iIdx0 = (intraPredAngle*y0) >> 5
iFact0 = (intraPredAngle*y0) & 31
predSample0 = ( 32 − iFact0 ) * refAbove[ x + iIdx0 + 1 ] + iFact0 *
refAbove[ x + iIdx0 + 2 ]
iIdx1 = (intraPredAngle*y1) >> 5
iFact1 = (intraPredAngle*y1) & 31
predSample1 = ( 32 − iFact1 ) * refBelow[ x − iIdx1 + 1 ] + iFact1 *
refBelow[ x − iIdx1 ]
d0 = \sqrt{(iIdx0 << 5 + iFact0)² + (y0 << 5)²}
d1 = \sqrt{(iIdx1 << 5 + iFact1)² + (y1 << 5)²}
predSample=( d1*predSample0+ d0*predSample1+((d1+ d0)>>1))/(d1+
d0)

Referring to Table 2, predSample corresponds to the target predicted sample 910, refAbove[m] represents a top reference sample with x coordinate being m, refBelow[n] represents a bottom reference sample whose x coordinate is n. Although Table 1 shows that the top reference and bottom reference samples are used, this is only an example. Alternatively, the left reference sample and the right reference sample, etc. may be used according to the prediction direction of the intra directional mode.

Meanwhile, a template matching prediction (TMP) method may be used for intra prediction. When the TMP method is used, the method may find a candidate template that is most similar to the target template for the target block in the current picture and may derive predicted samples for the target block based on the samples in the candidate template. Such a TMP method may increase the intra prediction efficiency when a certain pattern repeatedly appears in the current picture.

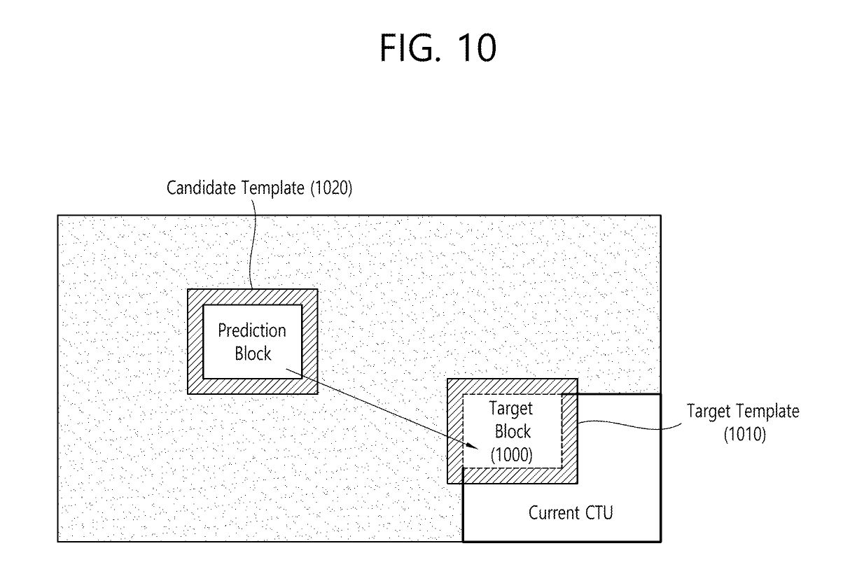

FIG. 10 illustrate an example TMP method according to the present invention.

Referring to FIG. 10, the neighboring reference samples to the target block 1000 in the current CTU may be used as the target template 1010 to detect the candidate template 1020 that is most similar to the target template 1010 in the entire region or a certain region of the current picture.

In this case, predicted samples for the target block 1000 may be derived based on reconstructed samples in the candidate template 1020. In this connection, the target block may be called the current block and may be one of CB, PB, or TB.

In applying the TMP method described above, the intra prediction performance may vary depending on how the target template 1010 to be compared is configured. According to the present invention, the left and top neighboring samples as well as the right and bottom samples may be used to construct the target template 1010.

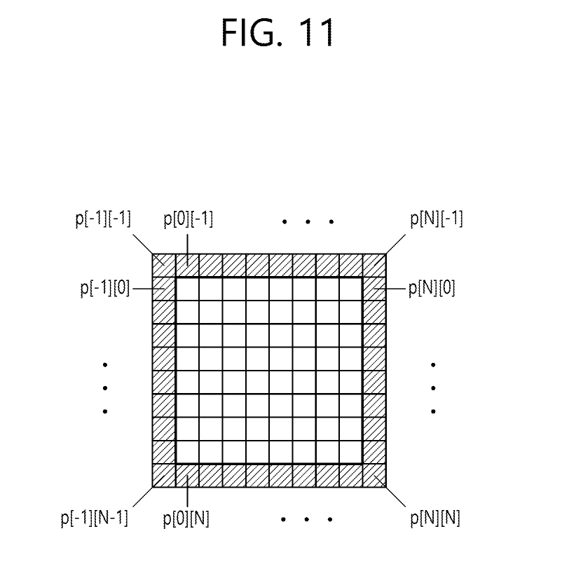

FIG. 11 shows an example of neighboring samples used for target template construction.

Referring to FIG. 11, for target template construction, bottom-left neighboring sample(p[−1][N], left neighboring samples(p[−1][N−1] . . . p[−1][0]), top-left neighboring sample(p[−1][−1]), top neighboring samples(p[0][−1] . . . p[N−1][−1]), top-right neighboring sample(p[N][−1]), right neighboring samples(p[N][N−1] . . . p[N][0]), bottom-right neighboring sample(p[N][N]), and bottom neighboring samples(p[0][N] . . . p[N−1][N]) may be used. When there are non-available samples among the neighboring samples, the non-available sample are filled with available samples via a substitution or padding procedure as described above.

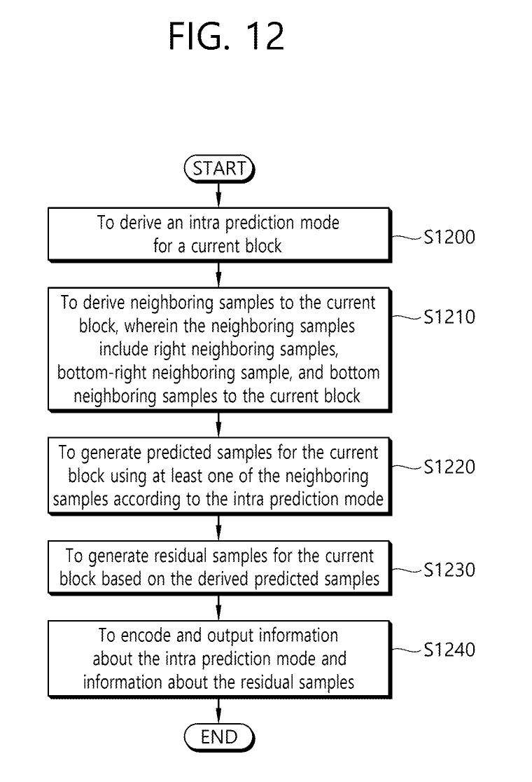

FIG. 12 illustrates schematically one example of an image coding method according to the present invention. The method disclosed in FIG. 12 may be performed by an encoding device.

Referring to FIG. 12, the encoding device derives an intra prediction mode for the current block (S1200). The encoding device may derive the optimal intra prediction mode for the current block based on the rate-distortion (RD) cost. The intra prediction mode may be one of two non-directional prediction modes and 34 or more than 34 (for example, 65) directional prediction modes. The two non-directional prediction modes may include the intra-DC mode and the intra-planar mode as described above.

The encoding device derives neighboring samples to the current block to perform the intra prediction (S1210). In this connection, the neighboring samples may include the samples as described above in FIGS. 6, 8, and 11. The neighboring samples may include left neighboring samples, top-left neighboring sample, top neighboring samples, right neighboring samples, bottom-right neighboring sample, and bottom neighboring samples to the current block.

When the sample size for the current block is N×N and the x component of the top-left sample position of the current block is 0 and they component thereof is 0, the bottom neighboring samples may be p[0][N] to p[N−1][N], and the bottom-right neighboring sample may be p[N][N], and the right neighboring samples may be p[N][N−1] to p[N][0].

In this connection, the neighboring samples may be already reconstructed samples. The current block is contained in the current CU (coding unit). The current CU is included in the current coding tree unit (CTU). The CUs belonging to the inter prediction mode among the CUs in the current CTU are decoded prior to the current CUs belonging to the intra prediction mode. This results in reconstructed samples for the CUs belonging to the inter prediction mode. At least one of the right neighboring samples, the bottom-right neighboring sample, and the bottom neighboring samples may be the reconstructed samples for CUs belonging to the inter prediction mode.

On the other hand, when at least one of the bottom neighboring samples, the bottom-right neighboring sample, and the right neighboring sample among the neighboring samples is non-available, the value of the non-available sample may be derived by substitution or padding procedures. In this connection, when at least one sample of the bottom neighboring samples, the bottom-right neighboring sample, and the right neighboring samples is positioned at the outer edge of the current picture, or another CU containing said at least one sample of the bottom neighboring samples, the bottom-right neighboring sample, and the right neighboring samples is not yet coded, said at least one sample may be determined to be non-available.

In one example of a substitution or padding procedure, the left neighboring samples are samples p[−1][2N−1] to p[−1][0], the top-left neighboring sample are samples p[−1][−1], and the top neighboring samples are samples p[0][−1] to p[2N−1][−1]. All of the bottom-right neighboring sample, the bottom-right neighboring sample, and the right neighboring sample may not be available. In this case, the value of the sample p[N][N] may be derived based on the sample p[−1][N] and the sample p[N][−1]. The value of the sample p[N][N] may be derived based on the sample p[−1][2N−1] and the sample p[2N−1][−1]. In this case, the value derived via the interpolation between the sample p[N][N] and the sample p[−1][N] may be allocated to each of the samples p[0][N] to p[N−1][N]. The value derived via the interpolation between the sample p[N][N] and the sample p[N][−1] may be assigned to each of the samples p[N][N−1] to p[N][0].

At least one sample among the bottom neighboring samples, the bottom-right neighboring sample and the right neighboring samples may be available.

In this case, when p[0][N] is non-available, the samples p[0][N] to p[N][N] are sequentially searched, and then the samples p[N][N−1] to p[N][0] are sequentially searched. The value of the first-found available sample may be substituted into the value of the p[0][N].

Further, when there is a non-available sample among the samples p[1][N] to p[N−1][N], the samples are sequentially searched from x=1, y=N to x=N, y=N. If the sample p[x][y] is non-available, the value of the sample p[x−1][y] may be substituted into the value of the non-available p[x][y].

Further, when there is a non-available sample among the samples p[N][N−1] to p[N][0], the samples are sequentially searched from x=N, y=N−1 to x=N, y=0. If the sample p[x][y] is non-available, the value of the sample p[x][y+1] may be substituted into the value of the non-available sample p[x][y]. Alternatively, the samples are sequentially searched from x=N, y=0 to x=N, y=N−1. If the sample p[x][y] is non-available, the value of the sample p[x][y−1] may be substituted into the value of the non-available sample p[x][y].

The encoding device generates predicted samples (or predicted samples array) for the current block using at least one of the neighboring samples according to the intra prediction mode (S1220).

In one example, when the intra prediction mode for the current block is intra directional mode, the predicted samples may be generated based on neighboring samples that are positioned in the prediction direction pointed by the intra directional mode (that is, based on neighboring samples that is positioned in the prediction direction from the predicted sample position). If the neighboring sample of the integer sample unit is not positioned in the prediction direction, a fractional sample value for the position indicated by the prediction direction may be generated via interpolating between neighboring samples of an integer sample unit neighboring to the position indicated by the prediction direction. Thus, the fractional sample value may be used. The prediction direction may include left, top-left, and top directions, as well as right, bottom, or bottom-right directions.

Further, in this case, according to the present invention, as described above with reference to FIG. 9, the value of the predicted sample may be derived based on the prediction direction indicated by the intra directional mode and the opposite direction to the prediction direction, as described above.

In another example, the intra prediction mode for the current block may be intra DC mode. In this case, a single value derived using the left neighboring samples, the right neighboring samples, the top neighboring samples and the bottom neighboring samples among the neighboring samples may be derived as the value of the predicted sample.

In still another example, the intra prediction mode for the current block may be intra planar mode. In this case, the value of the predicted sample may be derived using two samples that are positioned in the same column as the predicted sample and two samples that are positioned in the same row as the predicted sample among the neighboring samples.

In still another example, the intra prediction mode for the current block may be template matching prediction (TMP) mode. In this case, a candidate template corresponding to a target template is derived using the neighboring samples as the target template. The values of the predicted samples may be derived based on the reconstructed samples in the candidate template.

The encoding device generates residual samples (or residual samples array) for the current block based on the derived predicted samples (S1230). The encoding device may generate the residual samples based on the original samples and the predicted samples for the target block of the current picture.

The encoding device encodes and outputs the information about the intra prediction mode and the information about the residual samples (S1240). The encoding device may encode and output the information in a bitstream format. The bitstream may be transmitted to the decoding device over a network or using a storage medium. The information about the intra prediction mode may include information directly indicating an intra prediction mode for the current block. Alternatively, the information on the intra prediction mode may include information indicating a single candidate among the intra prediction mode candidate list derived based on the intra prediction mode of the left or top block to the current block. The information on the residual samples may include transform coefficients associated with the residual samples.

Further, when the values of the predicted samples are derived based on the prediction direction indicated by the intra directional mode and the opposite direction to the prediction direction, as described above with reference to FIG. 9, the information about the intra prediction mode may include a bi-directional prediction flag (or an intra-interpolation flag).

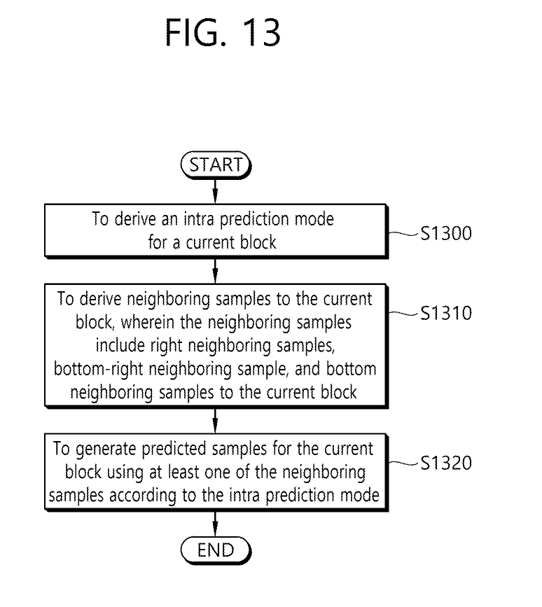

FIG. 13 illustrates schematically one example of the intra prediction method according to the present invention. The method disclosed in FIG. 13 may be performed by the decoding device.

Referring to FIG. 13, the decoding device derives an intra prediction mode for the current block (S1300). The decoding device may derive the optimal intra prediction mode for the current block based on the information about the intra prediction mode obtained from the bitstream. The bitstream may be received from the encoding device over the network or using a storage medium. The information about the intra prediction mode may include information directly indicating an intra prediction mode for the current block. Alternatively, the information on the intra prediction mode may include information indicating a single candidate among the intra prediction mode candidate list derived based on the intra prediction mode of the left or top block to the current block. Further, the information about the intra prediction mode may include a bi-directional prediction flag (or an intra-interpolation flag).

The decoding device derives neighboring samples to the current block to perform the intra prediction (S1310). In this connection, the neighboring samples may include the samples as described above in FIGS. 6, 8, and 11. The neighboring samples may include left neighboring samples, top-left neighboring sample, top neighboring samples, right neighboring samples, bottom-right neighboring sample, and bottom neighboring samples to the current block.

When the sample size for the current block is N×N and the x component of the top-left sample position of the current block is 0 and they component thereof is 0, the bottom neighboring samples may be p[0][N] to p[N−1][N], and the bottom-right neighboring sample may be p[N][N], and the right neighboring samples may be p[N][N−1] to p[N][0].

In this connection, the neighboring samples may be already reconstructed samples. The current block is contained in the current CU (coding unit). The current CU is included in the current coding tree unit (CTU). The CUs belonging to the inter prediction mode among the CUs in the current CTU are decoded prior to the current CUs belonging to the intra prediction mode. This results in reconstructed samples for the CUs belonging to the inter prediction mode. At least one of the right neighboring samples, the bottom-right neighboring sample, and the bottom neighboring samples may be the reconstructed samples for CUs belonging to the inter prediction mode.

On the other hand, when at least one of the bottom neighboring samples, the bottom-right neighboring sample, and the right neighboring sample among the neighboring samples is non-available, the value of the non-available sample may be derived by substitution or padding procedures. In this connection, when at least one sample of the bottom neighboring samples, the bottom-right neighboring sample, and the right neighboring samples is positioned at the outer edge of the current picture, or another CU containing said at least one sample of the bottom neighboring samples, the bottom-right neighboring sample, and the right neighboring samples is not yet coded, said at least one sample may be determined to be non-available.

In one example of a substitution or padding procedure, the left neighboring samples are samples p[−1][2N−1] to p[−1][0], the top-left neighboring sample are samples p[−1][−1], and the top neighboring samples are samples p[0][−1] to p[2N−1][−1]. All of the bottom-right neighboring sample, the bottom-right neighboring sample, and the right neighboring sample may not be available. In this case, the value of the sample p[N][N] may be derived based on the sample p[−1][N] and the sample p[N][−1]. The value of the sample p[N][N] may be derived based on the sample p[−1][2N−1] and the sample p[2N−1][−1]. In this case, the value derived via the interpolation between the sample p[N][N] and the sample p[−1][N] may be allocated to each of the samples p[0][N] to p[N−1][N]. The value derived via the interpolation between the sample p[N][N] and the sample p[N][−1] may be assigned to each of the samples p[N][N−1] to p[N][0].

At least one sample among the bottom neighboring samples, the bottom-right neighboring sample and the right neighboring samples may be available.

In this case, when p[0][N] is non-available, the samples p[0][N] to p[N][N] are sequentially searched, and then the samples p[N][N−1] to p[N][0] are sequentially searched. The value of the first-found available sample may be substituted into the value of the p[0][N].

Further, when there is a non-available sample among the samples p[1][N] to p[N−1][N], the samples are sequentially searched from x=1, y=N to x=N, y=N. If the sample p[x][y] is non-available, the value of the sample p[x−1][y] may be substituted into the value of the non-available p[x][y].

Further, when there is a non-available sample among the samples p[N][N−1] to p[N][0], the samples are sequentially searched from x=N, y=N−1 to x=N, y=0. If the sample p[x][y] is non-available, the value of the sample p[x][y+1] may be substituted into the value of the non-available sample p[x][y]. Alternatively, the samples are sequentially searched from x=N, y=0 to x=N, y=N−1. If the sample p[x][y] is non-available, the value of the sample p[x][y−1] may be substituted into the value of the non-available sample p[x][y].

The decoding device generates predicted samples (or predicted samples array) for the current block using at least one of the neighboring samples according to the intra prediction mode (S1320).

In one example, when the intra prediction mode for the current block is intra directional mode, the predicted samples may be generated based on neighboring samples that are positioned in the prediction direction pointed by the intra directional mode (that is, based on neighboring samples that is positioned in the prediction direction from the predicted sample position). If the neighboring sample of the integer sample unit is not positioned in the prediction direction, a fractional sample value for the position indicated by the prediction direction may be generated via interpolating between neighboring samples of an integer sample unit neighboring to the position indicated by the prediction direction. Thus, the fractional sample value may be used. The prediction direction may include left, top-left, and top directions, as well as right, bottom, or bottom-right directions.

Further, in this case, according to the present invention, as described above with reference to FIG. 9, the value of the predicted sample may be derived based on the prediction direction indicated by the intra directional mode and the opposite direction to the prediction direction, as described above.

In another example, the intra prediction mode for the current block may be intra DC mode. In this case, a single value derived using the left neighboring samples, the right neighboring samples, the top neighboring samples and the bottom neighboring samples among the neighboring samples may be derived as the value of the predicted sample.

In still another example, the intra prediction mode for the current block may be intra planar mode. In this case, the value of the predicted sample may be derived using two samples that are positioned in the same column as the predicted sample and two samples that are positioned in the same row as the predicted sample among the neighboring samples.

In still another example, the intra prediction mode for the current block may be template matching prediction (TMP) mode. In this case, a candidate template corresponding to a target template is derived using the neighboring samples as the target template. The values of the predicted samples may be derived based on the reconstructed samples in the candidate template.

On the other hand, although not shown, the decoding device may receive information about the residual samples for the current block from the bitstream. The information about the residual samples may include transform coefficients associated with the residual samples.

The decoding device may derive the residual samples (or residual samples array) for the current block based on the information about the residual samples. The decoding device may generate reconstructed samples based on the predicted samples and the residual samples and may derive a reconstructed block or a reconstructed picture based on the reconstructed samples. Thereafter, as described above, the decoding device may apply an in-loop filtering procedure such a SAO procedure and/or as a de-blocking filtering procedure to the reconstructed picture in order to improve subjective/objective picture quality as needed.

According to the present invention as described above, the coding sequence of the CUs as the basic processing units of the image, may be derived based on the prediction mode, thereby improving the coding efficiency of the CUs. Further, according to the present invention, intra prediction performance may be improved using extended neighboring reference samples.

The above description is only illustrative of the technical idea of the present invention. Therefore, those skilled in the art may make various modifications and variations to the above description without departing from the essential characteristics of the present invention. Accordingly, the embodiments disclosed herein are intended to be illustrative, not limiting, of the present invention. The scope of the present invention is not limited by these embodiments. The scope of protection of the present invention should be construed according to the following claims.

When the embodiments of the present invention are implemented in software, the above-described method may be implemented by modules (processes, functions, and so on) that perform the functions described above. Such modules may be stored in memory and executed by a processor. The memory may be internal or external to the processor, and the memory may be coupled to the processor using various well known means. The processor may comprise an application-specific integrated circuit (ASIC), other chipsets, a logic circuit and/or a data processing device. The memory may include a ROM (read-only memory), a RAM (random access memory), a flash memory, a memory card, a storage medium, and/or other storage device.

What is claimed is:

1. An intra prediction method performed by a decoding device, the method comprising:
deriving an intra prediction mode for a current block;
deriving neighboring samples to the current block; and
generating predicted samples for the current block using at least one of the neighboring samples according to the intra prediction mode,
wherein the derived neighboring samples include left neighboring samples, a top-left neighboring sample, top neighboring samples, right neighboring samples, a bottom-right neighboring sample, and bottom neighboring samples to the current block.

2. The method of claim 1, wherein the current block is included in a current CU (coding unit), wherein the current CU is included in a current coding tree unit (CTU),
wherein CUs belonging to an inter prediction mode among CUs in the current CTU are decoded prior to current CUs belonging to an intra prediction mode to generate reconstructed samples for CUs belonging to the inter prediction mode,
wherein at least one of the right neighboring samples, the bottom-right neighboring sample, and the bottom neighboring samples is the reconstructed sample for CUs belonging to the inter prediction mode.

3. The method of claim 1, wherein when a sample size of the current block is N×N, and a x component of a top-left sample position of the current block is 0 and a y component thereof is 0, the bottom neighboring samples are samples p[0][N] to p[N−1][N], and the bottom-right neighboring sample is a sample p[N][N], and the right neighboring samples are samples p[N][N−1] to p[N][0].

4. The method of claim 3, wherein when at least one of the bottom neighboring samples, the bottom-right neighboring sample, and the right neighboring sample is non-available, a value of the non-available sample is derived by a substitution procedure.

5. The method of claim 4, wherein when at least one sample of the bottom neighboring samples, the bottom-right neighboring sample, and the right neighboring samples is positioned at an outer edge of a current picture, or when another CU containing said at least one sample of the bottom neighboring samples, the bottom-right neighboring sample, and the right neighboring samples is not yet decoded, said at least one sample is determined to be non-available.

6. The method of claim 4, wherein when the left neighboring samples are samples p[−1][2N−1] to p[−1][0], the top-left neighboring sample is a sample p[−1][−1], and the top neighboring samples are samples p[0][−1] to p[2N−1][−1], and all of the bottom-right neighboring sample, the bottom-right neighboring sample, and the right neighboring samples are not available, a value of the sample p[N][N] is derived based on the sample p[−1][N] and the sample p[N][−1], or a value of the sample p[N][N] is derived based on the sample p[−1][2N−1] and the sample p[2N−1][−1],
wherein values derived via interpolation between the sample p[N][N] and the sample p[−1][N] are allocated to the samples p[0][N] to p[N−1][N] respectively,
wherein values derived via interpolation between the sample p[N][N] and the sample p[N][−1] are allocated to the samples p[N][N−1] to p[N][0] respectively.

7. The method of claim 4, wherein at least one sample of the bottom neighboring samples, the bottom-right neighboring sample and the right neighboring samples is available,
wherein when the sample p[0][N] is non-available, the samples p[0][N] to p[N][N] are sequentially searched, and then the samples p[N][N−1] to p[N][0] are sequentially searched,
wherein a value of a first-found available sample is substituted into a value of the p[0][N].

8. The method of claim 4, wherein at least one sample of the bottom neighboring samples, the bottom-right neighboring sample and the right neighboring samples is available, wherein the samples are sequentially searched from x=1, y=N to x=N, y=N, wherein if the sample p[x][y] is non-available, a value of a sample p[x−1][y] is substituted into a value of the non-available sample p[x][y].

9. The method of claim 8, wherein the samples are sequentially searched from x=N, y=N−1 to x=N, y=0, and, if the sample p[x][y] is non-available, a value of a sample p[x][y+1] may be substituted into a value of the non-available sample p[x][y]; alternatively,
the samples are sequentially searched from x=N, y=0 to x=N, y=N−1, and if the sample p[x][y] is non-available, a value of a sample p[x][y−1] is substituted into a value of the non-available sample p[x][y].

10. The method of claim 1, further comprising obtaining information about the intra prediction mode from bitstream,
wherein the intra prediction mode for the current block is one of two non-directional prediction modes and 65 directional prediction modes.

11. The method of claim 1, further comprising obtaining information about the intra prediction mode from bitstream,
wherein the intra prediction mode for the current block is the intra directional mode,
wherein a prediction direction indicated by the intra directional mode is a right, bottom, or bottom-right direction.

12. The method of claim 1, further comprising obtaining information about the intra prediction mode from bitstream,
wherein the intra prediction mode for the current block is an intra DC mode,
wherein a single value derived using the left neighboring samples, the right neighboring samples, the top neighboring samples, and the bottom neighboring samples among the neighboring samples is derived as a value of the predicted sample.

13. The method of claim 1, further comprising obtaining information about the intra prediction mode from bitstream,
wherein the intra prediction mode for the current block is an intra planar mode,
wherein a value of the predicted sample is derived using two samples positioned at the same column as the predicted sample and two samples positioned at the same row as the predicted sample among the neighboring samples.

14. The method of claim 1, further comprising obtaining information about the intra prediction mode from bitstream,
wherein the intra prediction mode for the current block is an intra directional mode,
wherein a value of the predicted sample is derived based on a prediction direction indicated by the intra directional mode and an opposite direction to the prediction direction.

15. The method of claim 1, further comprising obtaining information about the intra prediction mode from bitstream,
wherein the intra prediction mode for the current block is a template matching prediction (TMP) mode,
wherein a candidate template corresponding to a target template in a current picture is derived using the neighboring samples as the target template, and a value of the predicted sample is derived based on a reconstructed sample in the candidate template.
